(19) United States
(12) Patent Application Publication
(10) Pub. No.: US 2009/0268306 A1
(43) Pub. Date: Oct. 29, 2009

(54) ZOOM LENS

(75) Inventor: Toshihide HAYASHI, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 12/361,857

(22) Filed: Jan. 29, 2009

(30) Foreign Application Priority Data
Apr. 24, 2008 (JP) 2008-113668

(51) Int. Cl. G02B 15/14

(52) U.S. Cl. 359/676

(57) ABSTRACT

A zoom lens includes a first lens group including at least one positive lens and having a positive refractive power as a whole, a second lens group having a negative refractive power, a third lens group having a positive refractive power, and a fourth lens group having a positive refractive power wherein the first to the fourth lens groups are arranged sequentially from a subject. When magnification is varied from a wide angle end to a telephoto end, the second lens group is moved along an optical axis from the subject-side to an image plane. When given conditions are fulfilled, a small zoom lens with less manufacturing costs, high optical performance, and high magnification is realized.

### BACKGROUND OF THE INVENTION

1. Field of the Invention

The present invention pertains to a zoom lens with high optical performance.

2. Description of the Related Art

In recent years, further miniaturization and higher magnification of digital still cameras and of video cameras have been desired. In response to this demand, a miniaturized zoom lens with high magnification has been provided such as that disclosed in Japanese Laid-Open Patent Application Publication No. 2006-171615.

The zoom lens includes a first lens group having a positive refractive power, a second lens group having a negative refractive power, a third lens group having a positive refractive power, and a fourth lens group having a positive refractive power, the lens groups being arranged in this order from a subject-side. The second lens group is moved to change magnification and the fourth lens group is moved to perform focusing. The zoom lens has as zoom factor of approximately 20 times.

However, the entire length of the zoom lens disclosed in Japanese Laid-Open Patent Application Publication No. 2006-171615 tends to increase because higher magnification is achieved by a longer travel distance of the second lens group. If the magnification is fixed and the travel distance of the second lens group is limited to reduce the size of the zoom lens, the refractive power of the second lens group has to be increased. However, the higher the refractive power, the more sensitive the optical system. Consequently, manufacturing variations become prominent and yield rates decrease associated with resolution quality.

Further, the zoom lens disclosed in Japanese Laid-Open Patent Application Publication No. 2006-171615 includes, in the first lens group, a lens made of material with high anomalous dispersion to reduce chromatic aberration. Materials with high anomalous dispersion are expensive; hence, the manufacture of the zoom lens with such material increases the cost.

### SUMMARY OF THE INVENTION

It is an object of the present invention to at least solve the problems above associated with the conventional technologies.

A zoom lens according to one aspect of the present invention includes a first lens group including at least one positive lens and having a positive refractive power as a whole; a second lens group having a negative refractive power; a third lens group having a positive refractive power; and a fourth lens group having a positive refractive power. Further, the first to the fourth lens groups are arranged sequentially from a subject-side, magnification is varied when at least one lens group is moved, and conditions including 70≦νd≦81; 1.5≦OVL/(fₜ/f_{w})≦1.8; and 2.3≦OVL/M₂≦2.5 are fulfilled, where νd is an Abbe number of at least one positive lens included in the first lens group at d line, OVL is an entire length of the zoom lens, fₜ is a focal length of the zoom lens at a telephoto end, f_{w} is a focal length of the zoom lens at a wide angle end, and M₂ is a travel distance of the second lens group when the magnification is varied.

A zoom lens according to another aspect of the present invention includes a first lens group including at least one positive lens and having a positive refractive power as a whole; a second lens group having a negative refractive power; a third lens group having a positive refractive power; and a fourth lens group having a positive refractive power. Further, the first to fourth lens groups are arranged sequentially from a subject-side, magnification is varied when at least one lens group is moved, and conditions including 70≦νd≦81; 1.5≦OVL/(fₜ/f_{w})≦1.8; and 1.9≦|f₂|/f≦2.4 are fulfilled, where νd is Abbe number of at least one positive lens included in the first lens group at d line, OVL is an entire length of the zoom lens, fₜ is a focal length of the zoom lens at a telephoto end, f_{w} is a focal length of the zoom lens at a wide angle end, and f₂ is a focal length of the second lens group.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross section along an optical axis of a zoom lens according to an exemplary embodiment;

FIG. 2 depicts graphs of spherical aberration of the zoom lens;

FIG. 3 depicts graphs of chromatic aberration of magnification of the zoom lens; and

FIG. 4 depicts graphs of astigmatism and of distortion (d line) of the zoom lens.

### DETAILED DESCRIPTION OF THE PREFERRED EMBODIMENTS

Referring to the accompanying drawings, exemplary embodiments according to the present invention are explained in detail below.

A zoom lens according to exemplary embodiments includes a first lens group including one or more positive lenses and having a positive refractive power as a whole, a second lens group having a negative refractive power, a third lens group having a positive refractive power, and a fourth lens group having a positive refractive power, where the first to fourth lens groups are arranged sequentially from a subject-side. The second lens group is moved along an optical axis to vary magnification from a wide angle end to a telephoto end. In addition, when magnification is varied, the fourth lens group is moved so as to correct a change in the position of an image caused by a change in the distance to a subject.

It is preferable for a zoom lens according to the exemplary embodiments to satisfy condition (1) below when the Abbe number at the d line (λ=587.56 nm) of one positive lens included in the first lens group is ν_{d}:

70≦νd≦81 (1)

The condition (1) is an inequality expression that restricts the Abbe number at the d line of one positive lens included in the first lens group. Generally, when a lens is made of material with a large Abbe number νd at the d line, higher anomalous dispersion is obtained; however, the manufacturing cost also increases. Particularly when a material of νd>81 is used, the manufacturing cost becomes extremely high. On the other hand, when a material of νd<70 is used, the manufacturing cost can be reduced; however, chromatic aberration become prominent and resolution deteriorates. When the condition (1) is fulfilled, the manufacturing cost is reduced and a lens of high optical quality can be manufactured.

Further, it is preferable for the zoom lens according to the exemplary embodiments to satisfy condition (2) below where, OVL denotes the entire length of the zoom lens, fₜ denotes a focal length of the zoom lens at the telephoto end, and f_{w} denotes a focal length of the zoom lens at the wide angle end:

1.5≦OVL/(fₜ/f_{w})≦1.8 (2)

The condition (2) is an inequality expression that restricts the entire length with respect to a magnification ratio. When the condition (2) is met, the zoom lens has a high magnification capacity while maintaining a compact size. It is preferable for the value of OVL/(fₜ/f_{w}) to not exceed the upper limit of the condition (2) because the entire length of the optical system increases or higher magnification cannot be obtained. It is also preferable for the value of OVL/(fₜ/f_{w}) to not fall below the lower limit of the condition (2) because the optical performance of the zoom lens drops considerably.

Further, it is preferable for the zoom lens according to the exemplary embodiments to satisfy condition (3) below where, M₂ denotes a travel distance of the second lens group when magnification is varied:

2.3≦OVL/M₂≦2.5 (3)

The condition (3) is an inequality expression that restricts the entire length with respect to the travel distance of the second lens group when magnification is varied. When the condition (3) is met, the zoom lens has a high magnification capacity while maintaining a compact size. It is preferable for the value of OVL/M₂ to not exceed the upper limit of the condition (3) because the travel distance of the second lens group increases when magnification is varied, whereby the entire length of the optical system increases. It is further preferable for the value of OVL/M₂ to not fall below the lower limit because the sensitivity increases and the resolution drops considerably when tolerance increases from a design value.

Furthermore, it is preferable for the zoom lens according to the exemplary embodiments to satisfy condition (4) below where, f₂ denotes a focal distance of the second lens group:

1.9<|f₂|/f_{w}≦2.4 (4)

The condition (4) is an inequality expression that restricts the refractive power of the second lens group. When the condition (4) is met, deterioration of the optical performance of the second lens group due to manufacturing variation is prevented. It is preferable for the value of |f₂|/f_{w} to not exceed the upper limit of the condition (4) because the travel distance of the second lens group increases when magnification is varied and the entire length of the optical system increases. It is further preferable for the value of |f₂|/f_{w} to not fall below the lower limit of the condition (4) because the sensitivity increases and the resolution drops considerably when tolerance increases from a design value.

As explained above, when the conditions (1) to (4) are fulfilled, the zoom lens according to the exemplary embodiments has a lower manufacturing cost and is compact with a high magnification capacity of more than approximately 40 times. In addition, the resolution of the zoom lens does not degrade even if tolerance increases from a design value. In other words, the zoom lens according to the embodiments is not subject to low yield rates associated with resolution quality.

The zoom lens according to the exemplary embodiments does not have to fulfill all of the conditions (1) to (4). When at least conditions (1) to (3) or the conditions (1), (2), and (4) are fulfilled, a zoom lens with a low manufacturing cost, high optical performance, a high magnification capacity, and a compact size can be provided.

The zoom lens according to the exemplary embodiments may include at least one aspheric lens. In this way, various kinds of aberration over the entire magnifying region are corrected with fewer lenses, whereby higher optical performance is maintained.

The zoom lens according to the exemplary embodiments may include at least one lens of resin material. In this way, a lighter optical system is obtained. In addition, since the resin material is easy to cast, manufacturing cost decreases.

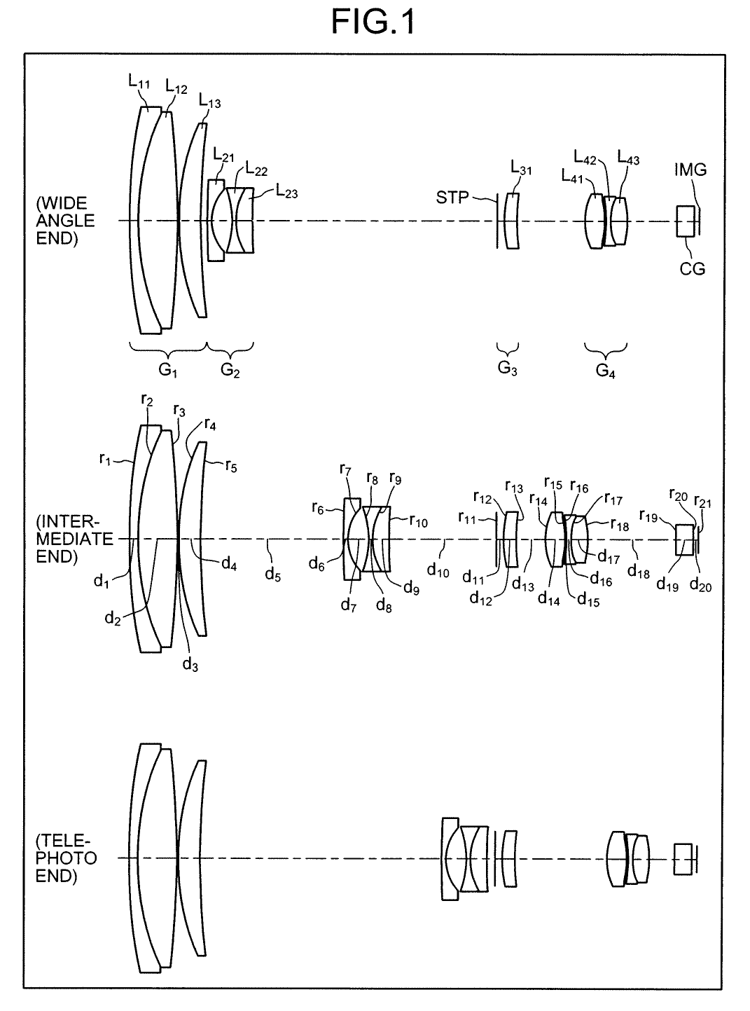

FIG. 1 is a cross section along an optical axis of a zoom lens according to an exemplary embodiment. The zoom lens includes a first lens group G₁ having a positive refractive power, a second lens group G₂ having a negative refractive power, a third lens group G₃ having a positive refractive power, and a fourth lens group G₄ having a positive refractive power, the first to the fourth lens groups G1 to G4 being arranged in this order from a subject (not depicted). An optical diaphragm STP providing a given aperture is disposed between the second lens group G₂ and the third lens group G₃. A cover glass CG is disposed between the fourth lens group G₄ and an image plane IMG. The cover glass CG is disposed as needed and thus may be omitted. On the image plane IMG, a receiving surface of a charge-coupled device (CC) or complementary metal-oxide-semiconductor (CMOS) imaging device is set.

The first lens group G₁ includes a first lens L₁₁ having a negative refractive power, a second lens L₁₁ having a positive refractive power, and a third lens L₁₃ having a positive refractive power, the first to the third lenses L₁₁ to L₁₃ arranged in this order from the subject. The first lens L₁₁ is a meniscus lens with a convex surface directed toward the subject. The first lens L₁₁ and the second lens L₁₂ are cemented.

The second lens group G₂ includes a first lens L₂₁ having a negative refractive power, a second lens L₂₂ having a negative refractive power, and a third lens L₂₃ having a positive refractive power, the first to the third lenses L₂₁ to L₂₃ arranged in this order from the subject. The first lens L₂₁ is a meniscus lens with a convex surface directed toward the subject. The second lens L₂₂ and the third lens L₂₃ are cemented. A surface of the second lens L₂₂ directed toward the subject is aspheric.

The third lens group G₃ includes a lens L₃₁ having a positive refractive power. The lens L₃₁ may be made of resin.

The fourth lens group G₄ includes a first lens L₄₁ having a positive refractive power, a second lens L₄₂ having a negative refractive power, and a third lens L₄₃ having a positive refractive power, the first to the third lenses L₄₁ to L₄₃ arranged in this order from the subject. The second lens L₄₂ and the third lens L₄₃ are cemented. Both surfaces of the second lens L₄₂ are aspheric.

The second lens group G₂ is moved along the optical axis of the zoom lens from the subject-side to the IMG-side to vary magnification from the wide angle end to the telephoto end. The fourth lens G₄ is also moved along the optical axis when magnification is varied, thereby correcting changes in the position of the image plane caused by change of the subject distance, the movement depicting a path forming a U-turn near the telephoto end. The first lens group G₁ and the third lens group G₃ are fixed.

Numeric data concerning the zoom lens according to the exemplary embodiments are as follows:
Entire length of zoom lens (OVL)=65.188;
Focal distance at wide angle end of zoom lens (f_{w})=2.05;
Focal distance at telephoto end of zoom lens (fₜ)=81.65;
Travel distance of second lens group G₂ when magnification is varied (M₂)=26.206;
Focal distance of second lens group G₂ (f₂)=−4.743;
Field angle (2ω)=4.52° (telephoto end) to 137.08° (wide angle end);

### (Concerning the Condition (1))

νd=70.44;

### (Concerning the Condition (2))

OVL/(fₜ/f_{w})=1.637;

### (Concerning the Condition (3))

OVL/M₂=2.488;

### (Concerning the Condition (4))

|f₂|/f_{w}=2.314;
r₁=54.2

d₁=1, nd₁=1.846663, νd₁=23.78;
r₂=26.3

d₂=4.4, nd₂=1.487489, νd₂=70.44;
r₃=−100.6

d₃=0.15
r₄=23.4

d₄=2.5, nd₃=1.743299, νd₃=49.22
r₅=72

d₅=0.7400 (wide angle end) to 18.602 (intermediate end) to 26.94 (telephoto end)
r₆=63.4

d₆=0.5, nd₄=1.834, νd₄=37.35
r₇=4.58

d₇=2.3
r₈=−9.05 (aspheric surface)

d₈=0.5 nd₅=1.516798, νd₅=64.2
r₉=6.2

d₉=1.8, nd₆=1.846663, νd₆=23.78
r₁₀=33.5

d₁₀=27.406 (wide angle end) to 9.544 (intermediate end) to 1.200 (telephoto end)
r₁₁=∞ (diaphragm)

d₁₁=0.8
r₁₂=10.3159

d₁₂=1.45, nd₇=1.5247, νd₇=56.24
r₁₃=24.1358

d₁₃=7.579 (wide angle end) to 4.137 (intermediate end) to 10.327 (telephoto end)
r₁₄=6.4881

d₁₄=2.18, nd₈=1.58313, νd₈=59.46
r₁₅=−10.2336

d₁₅=0.15
r₁₆=−16.91 (aspheric surface)

d₁₆=0.53, nd₉=1.834, νd₉=37.35
r₁₇=5.8 (aspheric surface)

d₁₇=1.85, nd₁₀=1.487489, νd₁₀=70.44
r₁₈=−10.26

d₁₈=5.583 (wide angle end) to 9.0258 (intermediate end) to 2.825 (telephoto end)
d₁₉=1.87, nd₁₁=1.51680, νd₁₁=64.2
r₂₀=∞

d₂₀=1.9
r₂₁=∞ (image plane)

### (Conic Constant ε and Constants A, B, C, D, E)

### (Eighth Surface)

ε=1, A=0,
B=−1.406922×10⁻⁴, C=7.618560×10⁻⁶,
D=−1.936182×10⁻⁶, E=8.388272×10⁻⁸;

### (Sixteenth Surface)

ε=1, A=0,
B=−2.997188×10⁻⁴, C=2.328742×10⁻⁵,
D=−2.776323×10⁻⁶, E=3.525980×10⁻⁷;

### (Seventeenth Surface)

ε=1, A=0,
B=7.363591×10⁻⁴, C=−8.495703×10⁻⁶,
D=1.859080×10⁻⁶, E=1.557849×10⁻⁷;

Where, r₁, r₂, . . . denote a curvature of a lens, a surface of the diaphragm and so on; d₁, d₂, . . . denote a thickness of a lens, the diaphragm and so on, or a distance between lenses, or lens and diaphragm, etc.; nd₁, nd₂, . . . denote a refractive index of, for example, a lens at the d line (λ=587.56 nm); νd₁, νd₂, . . . denote the Abbe number of, for example, a lens at the d line (λ=587.56 nm).

The aspheric surface is described by the following equation where H denotes a distance from an optical axis, X(H) denotes a height of surface at a height H from the vertex:

$$X ( H ) = \frac{{H}^{2} / R}{1 + \sqrt{1 - ( ɛ {H}^{2} / {R}^{2} )}} + {AH}^{2} + {BH}^{4} + {CH}^{6} + {DH}^{8} + {EH}^{10} \qquad ( 1 )$$

Where, R denotes a paraxial radius of curvature, ε denotes a conic constant, and A, B, C, D, E are aspheric coefficients of the second power, the fourth power, the sixth power, the eighth power, and the tenth power respectively.

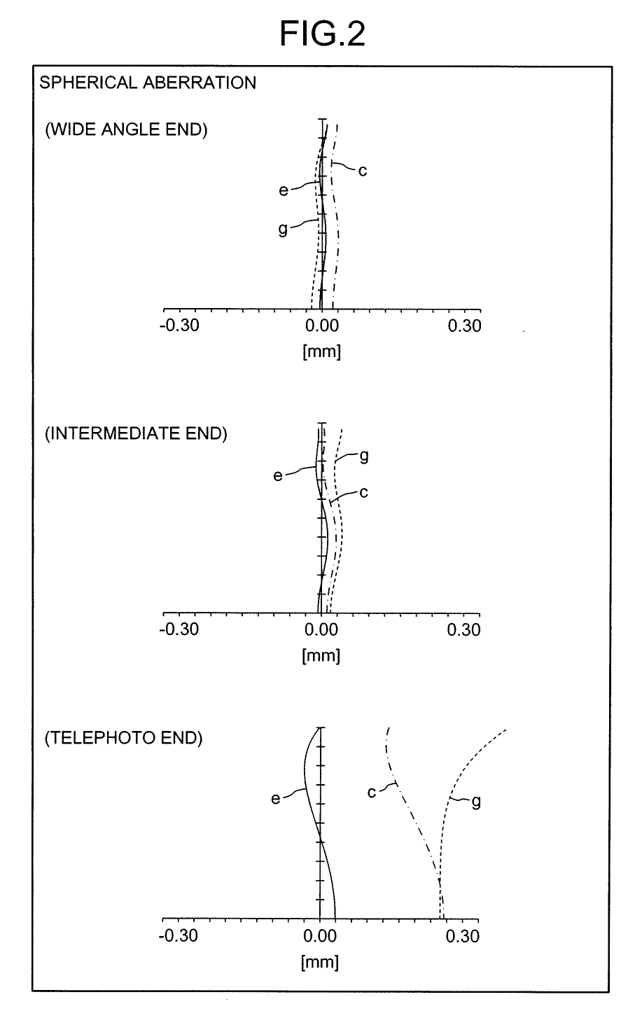

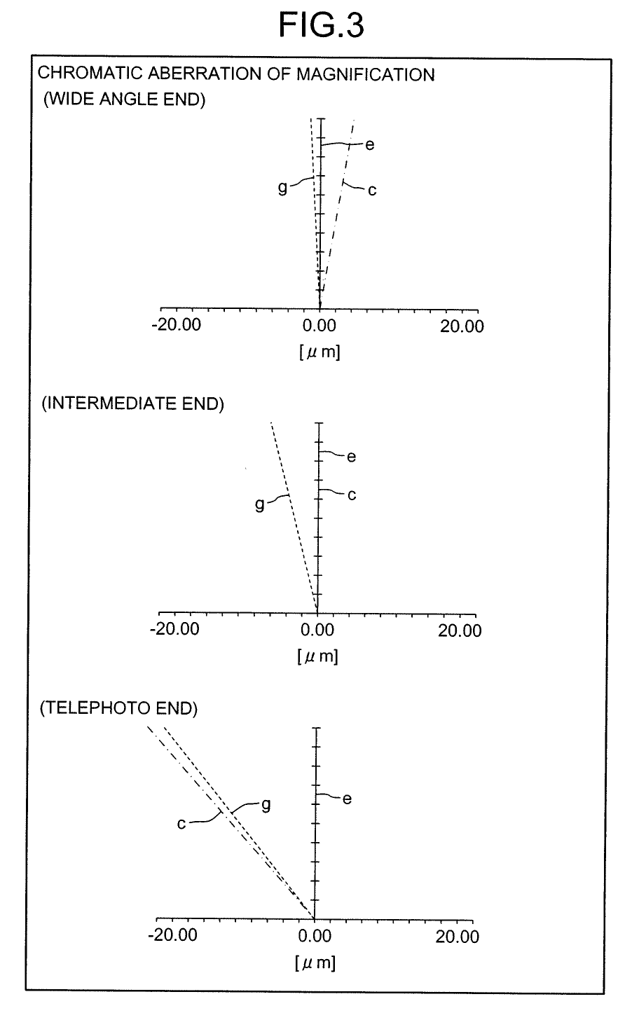

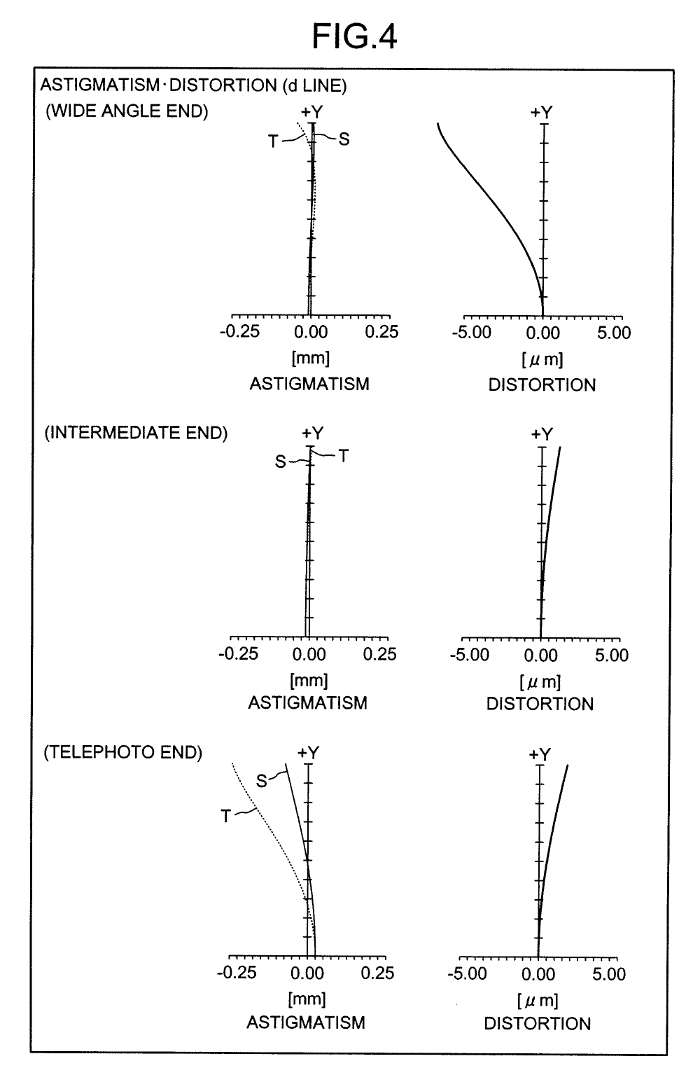

FIG. 2 depicts graphs of spherical aberration of the zoom lens according to the exemplary embodiments. FIG. 3 depicts graphs of chromatic aberration of magnification of the zoom lens according to the exemplary embodiments. In FIGS. 2 and 3, e indicates aberration of wavelength at the e line (λ=546.07 nm), g indicates aberration of wavelength at the g line (λ=435.84 nm), c indicates aberration of wavelength at the c line (λ=656.27 nm). FIG. 4 depicts graphs of astigmatism and of distortion (d line) of the zoom lens according to the exemplary embodiments. In FIG. 4, S denotes aberration along the sagittal direction and T denotes aberration along the tangential direction.

As explained, when the conditions above are fulfilled, the manufacturing cost of zoom lens is reduced and a compact zoom lens having a magnification capacity of more than 40 times is obtained. The resolution of the zoom lens does not deteriorate even if tolerance from a design value increases. In other words, the zoom lens according to the embodiments is not subject to low yield rates associated with resolution quality.

The zoom lens according to the exemplary embodiments includes cemented lenses, thereby preventing various kinds of aberration.

Furthermore, the zoom lens according to the exemplary embodiments includes aspheric lenses, thereby effectively correcting various kinds of aberration with fewer lenses, reducing the size and the weight of the optical system, and decreasing the manufacturing cost. When lenses are made of resin material, the optical system becomes lighter.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2008-113668 filed in Japan on Apr. 24, 2008.

What is claimed is:

1. A zoom lens comprising:
a first lens group including at least one positive lens and having a positive refractive power as a whole;
a second lens group having a negative refractive power;
a third lens group having a positive refractive power;
a fourth lens group having a positive refractive power, wherein
the first to the fourth lens groups are arranged sequentially from a subject-side,
a magnification power is varied when at least one lens group is moved, and
conditions:
70≦μd≦81;
1.5≦OVL/(fₜ/f_{w})≦1.8; and
2.3≦OVL/M₂≦2.5
are fulfilled, where ν_{d} is an Abbe number of at least one positive lens included in the first lens group at d line, OVL is an entire length of the zoom lens, fₜ is a focal length of the zoom lens at a telephoto end, f_{w} is a focal length of the zoom lens at a wide angle end, and M₂ is a travel distance of the second lens group when the magnification is varied.

2. The zoom lens according to claim 1, wherein a condition:
1.9≦|f₂|/f_{w}≦2.4
is fulfilled, where f₂ is a focal distance of the second lens group.

3. A zoom lens comprising:
a first lens group including at least one positive lens and having a positive refractive power as a whole;
a second lens group having a negative refractive power;
a third lens group having a positive refractive power;
a fourth lens group having a positive refractive power, wherein
the first to fourth lens groups are arranged sequentially from a subject-side,
a magnification power is varied when at least one lens group is moved, and
conditions:
70≦νd≦81;
1.5≦OVL/(fₜ/f_{w})≦1.8; and
1.9≦|f₂|/f_{w}≦2.4
are fulfilled, where νd is Abbe number of at least one positive lens included in the first lens group at d line, OVL is an entire length of the zoom lens, fₜ is a focal length of the zoom lens at a telephoto end, f_{w} is a focal length of the zoom lens at a wide angle end, and f₂ is a focal length of the second lens group.
